(19) United States
(12) Patent Application Publication
(10) Pub. No.: US 2025/0063427 A1
(43) Pub. Date: Feb. 20, 2025

(54) METHOD, DEVICE, AND SYSTEM FOR AWARENESS BASED DATA TRANSMISSION AND RECEPTION IN WIRELESS NETWORKS

(71) Applicant: ZTE Corporation, Shenzhen (CN)

(72) Inventors: Xiubin SHA, Shenzhen (CN); He HUANG, Shenzhen (CN); Bo DAI, Shenzhen (CN); Yuan GAO, Shenzhen (CN); Eswar Kalyan VUTUKURI, Shenzhen (CN)

(73) Assignee: ZTE Corporation, Shenzhen (CN)

(21) Appl. No.: 18/936,535

(22) Filed: Nov. 4, 2024

Related U.S. Application Data
(63) Continuation of application No. PCT/CN2022/111334, filed on Aug. 10, 2022.

(51) Int. Cl. H04W 28/06; H04W 80/02

(52) U.S. Cl. CPC H04W 28/06; H04W 80/02

(57) ABSTRACT

This disclosure relates generally to a method, device, and system for congestion control in a wireless network. One method performed by a first network element is disclosed. The method may include: providing, to a second network element, a first discard indication indicating a list of PDUs or a list of discarded PDU sets, each discarded PDU set in the list of discarded PDU sets comprising a list of PDUs, wherein the first discard indication triggers the second network element to discard the list of discarded PDUs or the list of discarded PDU sets; or providing, to the second network element, a second discard indication indicating that a PDU is discarded or a PDU set is discarded, wherein the second discard indication triggers the second network element to discard the PDU or the PDU set.

### TECHNICAL FIELD

This disclosure is directed generally to wireless communications, and particularly to a method, device, and system for awareness-based data transmission in a wireless network.

### BACKGROUND

With the development of wireless communication technologies, more and more devices and applications require high date rate and low latency. Such applications include Extended Reality (XR), virtual reality (VR), Mixed Reality (MR), video streaming, etc. Efficient and robust congestion control and mitigation mechanism is critical for supporting these applications. Identification and awareness of data packets that are dropped may be utilized by a receiving entity, so the receiving entity may be aware of these data packets dropped as early as possible.

Controlling power consumption and reducing energy cost is critical for developing and deploying a wireless communication network. Energy saving technology is critical for achieving this goal. It is beneficial for a network element to transition to sleep mode as soon as possible, once it is determined there is transmission task pending for the network element. Such transition also needs coordination between various network elements.

### SUMMARY

This disclosure is directed to a method, device, and system for awareness-based data transmission in a wireless network.

In some embodiments, a method performed by a first network element is disclosed. The method may include: providing, to a second network element, a first discard indication indicating a list of discarded Protocol Data Units (PDUs) or a list of discarded PDU sets, each discarded PDU set in the list of discarded PDU sets comprising a list of PDUs, wherein the first discard indication triggers the second network element to discard the list of discarded PDUs or the list of discarded PDU sets; or providing, to the second network element, a second discard indication indicating that a PDU is discarded or a PDU set is discarded, wherein the second discard indication triggers the second network element to discard the PDU or the PDU set.

In some embodiments, a method performed by a first network element is disclosed. The method may include: receiving, from a second network element and by a receiving entity hosted in the first network element, a discard indication indicating a list of discarded PDUs or a list of discarded PDU sets, each PDU set in the list of discarded PDU sets comprising a list of PDUs; and dropping the list of discarded PDUs or the list of discarded PDU sets at a receiving layer corresponding to the receiving entity.

In some embodiments, a method performed by a wireless device is disclosed. The method may include: transmitting, to a network element, an indication indicating that an uplink transmission is complete; and in response to transmitting the indication, stopping monitoring a Physical Downlink Control Channel (PDCCH) in a current Discontinuous Reception (DRX) cycle.

In some embodiments, a method performed by a wireless device is disclosed. The method may include: receiving, from a network element, an indication indicating that a downlink transmission is complete; and in response to receiving the indication, stopping monitoring a PDCCH in a current DRX cycle.

In some embodiments, a method performed by a wireless device is disclosed. The method may include: ending an on-duration time period in a DRX cycle in response to receiving from a base station one of: a MACE CE message, the MAC CE message being identified by a dedicated downlink LC-ID and comprising no data payload; a DCI message indicating an end of the on-duration time period; or an ending flag to trigger the end of the on-duration time period; and ending the on-duration time period in the DRX cycle in response to a DRX on-duration timer expiring.

In some embodiments, a method performed by a wireless device is disclosed. The method may include: transmitting, to a base station, an indication indicating that an on-duration time period in a DRX cycle is ending.

In some embodiments, there is a wireless device or a network element comprising a processor and a memory, wherein the processor is configured to read code from the memory and implement any methods recited in any of the embodiments.

In some embodiments, a computer program product comprising a computer-readable program medium code stored thereupon, the code, when executed by a processor, causing the processor to implement any method recited in any of the embodiments.

The above embodiments and other aspects and alternatives of their implementations are described in greater detail in the drawings, the descriptions, and the claims below.

### BRIEF DESCRIPTION OF THE DRAWINGS

FIG. 1 shows an example wireless communication network.

FIG. 2 shows an example wireless network node.

FIG. 3 shows an example user equipment.

FIG. 4 shows an exemplary application frame to Internet Protocol (IP) packet mapping.

FIG. 5 shows an exemplary protocol stack in a UE and base station.

FIGS. 6A and 6B shows exemplary message flows for transmitting PDU discard indication or PDU set discard indication between peer entites.

FIGS. 7A-7L shows various exemplary PDUs for PDU discard indication or PDU set discard indication.

FIGS. 8A-8B show various receiving entities with SDU or SDU set integrity checkin.

FIG. 9 shows an exemplary message flow for uplink transmission end indication or PDU set transmission end indication.

FIG. 10 shows an exemplary message flow for PDCCH monitoring end indication or on-duration timer end indication.

FIG. 11A shows an exemplary Discontinuous Reception (DRX) cycle with fixed DRX on-duration.

FIG. 11B shows an exemplary DRX cycle with sliding DRX on-duration.

FIG. 12 shows an exemplary message flow for transmitting PDU set related parameters.

FIGS. 13A-13C shows various exemplary message flow for exchanging congestion indication information.

### DETAILED DESCRIPTION

### Wireless Communication Network

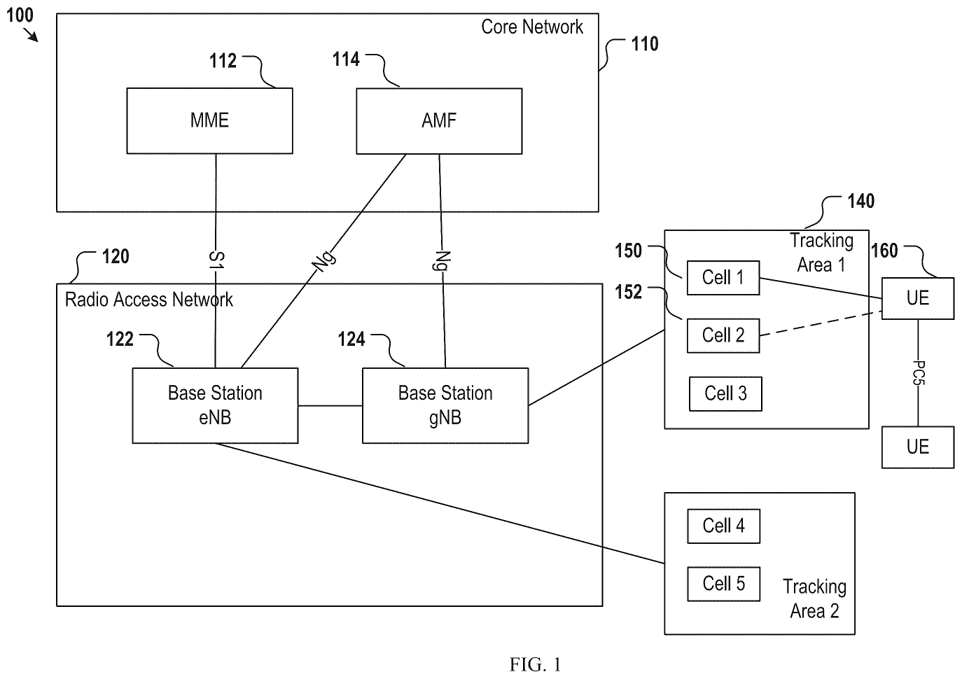

FIG. 1 shows an exemplary wireless communication network 100 that includes a core network 110 and a radio access network (RAN) 120. The core network 110 further includes at least one Mobility Management Entity (MME) 112 and/or at least one Access and Mobility Management Function (AMF). Other functions that may be included in the core network 110 are not shown in FIG. 1. The RAN 120 further includes multiple base stations, for example, base stations 122 and 124. The base stations may include at least one evolved NodeB (eNB) for 4G LTE, an enhanced LTE eNB (ng-eNB), or a Next generation NodeB (gNB) for 5G New Radio (NR), or any other type of signal transmitting/receiving device such as a UMTS NodeB. The eNB 122 communicates with the MME 112 via an SI interface. Both the eNB 122 and gNB 124 may connect to the AMF 114 via an Ng interface. Each base station manages and supports at least one cell. For example, the base station gNB 124 may be configured to manage and support cell 1, cell 2, and cell 3.

The gNB 124 may include a central unit (CU) and at least one distributed unit (DU). The CU and the DU may be co-located in a same location, or they may be split in different locations. The CU and the DU may be connected via an F1 interface. Alternatively, for an eNB which is capable of connecting to the 5G network, it may also be similarly divided into a CU and at least one DU, referred to as ng-eNB-CU and ng-eNB-DU, respectively. The ng-eNB-CU and the ng-eNB-DU may be connected via a W1 interface.

The wireless communication network 100 may include one or more tracking areas. A tracking area may include a set of cells managed by at least one base station. For example, tracking area 1 labeled as 140 includes cell 1, cell 2, and cell 3, and may further include more cells that may be managed by other base stations and not shown in FIG. 1. The wireless communication network 100 may also include at least one UE 160. The UE may select a cell among multiple cells supported by a base station to communication with the base station through Over the Air (OTA) radio communication interfaces and resources, and when the UE 160 travels in the wireless communication network 100, it may reselect a cell for communications. For example, the UE 160 may initially select cell 1 to communicate with base station 124, and it may then reselect cell 2 at certain later time point. The cell selection or reselection by the UE 160 may be based on wireless signal strength/quality in the various cells and other factors.

The wireless communication network 100 may be implemented as, for example, a 2G, 3G, 4G/LTE, or 5G cellular communication network. Correspondingly, the base stations 122 and 124 may be implemented as a 2G base station, a 3G NodeB, an LTE eNB, or a 5G NR gNB. The UE 160 may be implemented as mobile or fixed communication devices which are capable of accessing the wireless communication network 100. The UE 160 may include but is not limited to mobile phones, laptop computers, tablets, personal digital assistants, wearable devices, Internet of Things (IoT) devices, MTC/eMTC devices, distributed remote sensor devices, roadside assistant equipment, XR devices, and desktop computers. The UE 160 may also be generally referred to as a wireless communication device, or a wireless terminal. The UE 160 may support sidelink communication to another UE via a PC5 interface.

While the description below focuses on cellular wireless communication systems as shown in FIG. 1, the underlying principles are applicable to other types of wireless communication systems for paging wireless devices. These other wireless systems may include but are not limited to Wi-Fi, Bluetooth, ZigBee, and WiMax networks.

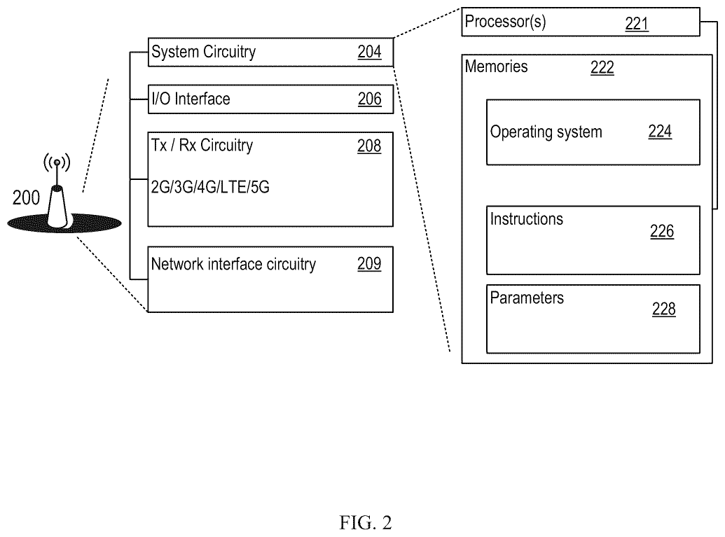

FIG. 2 shows an example of electronic device 200 to implement a network base station (e.g., a radio access network node), a core network (CN), and/or an operation and maintenance (OAM). Optionally in one implementation, the example electronic device 200 may include radio transmitting/receiving (Tx/Rx) circuitry 208 to transmit/receive communication with UEs and/or other base stations. Optionally in one implementation, the electronic device 200 may also include network interface circuitry 209 to communicate the base station with other base stations and/or a core network, e.g., optical or wireline interconnects, Ethernet, and/or other data transmission mediums/protocols. The electronic device 200 may optionally include an input/output (I/O) interface 206 to communicate with an operator or the like.

The electronic device 200 may also include system circuitry 204. System circuitry 204 may include processor(s) 221 and/or memory 222. Memory 222 may include an operating system 224, instructions 226, and parameters 228. Instructions 226 may be configured for the one or more of the processors 221 to perform the functions of the network node. The parameters 228 may include parameters to support execution of the instructions 226. For example, parameters may include network protocol settings, bandwidth parameters, radio frequency mapping assignments, and/or other parameters.

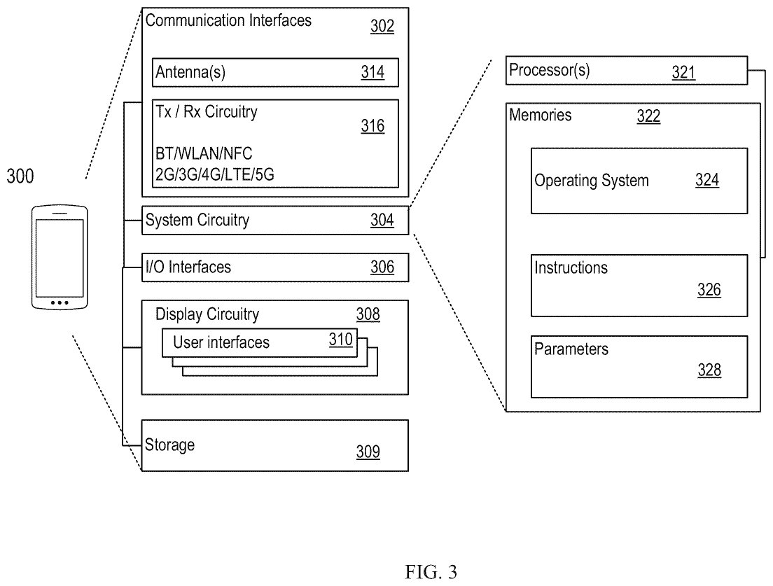

FIG. 3 shows an example of an electronic device to implement a terminal device 300 (for example, a user equipment (UE)). The UE 300 may be a mobile device, for example, a smart phone or a mobile communication module disposed in a vehicle. The UE 300 may include a portion or all of the following: communication interfaces 302, a system circuitry 304, an input/output interfaces (I/O) 306, a display circuitry 308, and a storage 309. The display circuitry may include a user interface 310. The system circuitry 304 may include any combination of hardware, software, firmware, or other logic/circuitry. The system circuitry 304 may be implemented, for example, with one or more systems on a chip (SoC), application specific integrated circuits (ASIC), discrete analog and digital circuits, and other circuitry. The system circuitry 304 may be a part of the implementation of any desired functionality in the UE 300. In that regard, the system circuitry 304 may include logic that facilitates, as examples, decoding and playing music and video, e.g., MP3, MP4, MPEG, AVI, FLAC, AC3, or WAV decoding and playback; running applications; accepting user inputs; saving and retrieving application data; establishing, maintaining, and terminating cellular phone calls or data connections for, as one example, internet connectivity; establishing, maintaining, and terminating wireless network connections, Bluetooth connections, or other connections; and displaying relevant information on the user interface 310. The user interface 310 and the inputs/output (I/O) interfaces 306 may include a graphical user interface, touch sensitive display, haptic feedback or other haptic output, voice or facial recognition inputs, buttons, switches, speakers and other user interface elements. Additional examples of the I/O interfaces 306 may include microphones, video and still image cameras, temperature sensors, vibration sensors, rotation and orientation sensors, headset and microphone input/output jacks, Universal Serial Bus (USB) connectors, memory card slots, radiation sensors (e.g., IR sensors), and other types of inputs.

Referring to FIG. 3, the communication interfaces 302 may include a Radio Frequency (RF) transmit (Tx) and receive (Rx) circuitry 316 which handles transmission and reception of signals through one or more antennas 314. The communication interface 302 may include one or more transceivers. The transceivers may be wireless transceivers that include modulation/demodulation circuitry, digital to analog converters (DACs), shaping tables, analog to digital converters (ADCs), filters, waveform shapers, filters, pre-amplifiers, power amplifiers and/or other logic for transmitting and receiving through one or more antennas, or (for some devices) through a physical (e.g., wireline) medium. The transmitted and received signals may adhere to any of a diverse array of formats, protocols, modulations (e.g., QPSK, 16-QAM, 64-QAM, or 256-QAM), frequency channels, bit rates, and encodings. As one specific example, the communication interfaces 302 may include transceivers that support transmission and reception under the 2G, 3G, BT, WiFi, Universal Mobile Telecommunications System (UMTS), High Speed Packet Access (HSPA)+, 4G/Long Term Evolution (LTE), and 5G standards. The techniques described below, however, are applicable to other wireless communications technologies whether arising from the 3rd Generation Partnership Project (3GPP), GSM Association, 3GPP2, IEEE, or other partnerships or standards bodies.

Referring to FIG. 3, the system circuitry 304 may include one or more processors 321 and memories 322. The memory 322 stores, for example, an operating system 324, instructions 326, and parameters 328. The processor 321 is configured to execute the instructions 326 to carry out desired functionality for the UE 300. The parameters 328 may provide and specify configuration and operating options for the instructions 326. The memory 322 may also store any BT, WiFi, 3G, 4G, 5G or other data that the UE 300 will send, or has received, through the communication interfaces 302. In various implementations, a system power for the UE 300 may be supplied by a power storage device, such as a battery or a transformer.

### Application Data Mapping to PDU/PDU Set

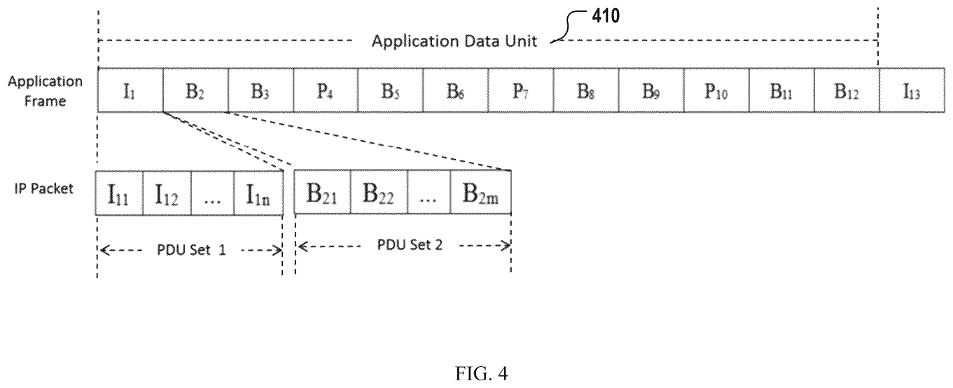

In a wireless communication network, various applications may run in a wireless terminal, such as a UE. Some applications, such as XR, VR, MR, video streaming, etc., require high data rate and low latency. Each application may need to transmit and/or receive data from the wireless communication network. At an application level, the data may be represented as data unit. For example, for a video related application, there may exist frames of various types, such as an I-frame, a P-frame, and a B-frame. Referring to FIG. 4, an example application data unit 410 includes multiple application frames. For data transmission in the wireless communication network, each application frame may be transmitted via multiple Internet Protocol (IP) packets. For example, I-frame I₁ may be mapped to n IP packets, and B-frame B₂ may be mapped to m IP packets, where n and m are positive integers. The multiple IP packets corresponding to a same application frame may be grouped together, to form a Protocol Data Unit (PDU) set. Note that a PDU set includes all necessary information for re-constructing its corresponding application frame. In addition to the mapping from an application frame to a PDU set as shown in FIG. 4, a PDU set may also be mapped from other sources, such as a media unit, a media slice, a video/audit tile, haptic application information, etc.

Each PDU set may be assigned a Quality of Service (QOS) requirement, for example, based on the source information mapped to it. Using the application frame as an example, the QoS requirement of the PDU set may be assigned based on the type of the mapped application frame. Different (de-)coding schemes may be applied to different type of application frames, and the QoS priority or importance of different type of frames are different. Details are described below.

An I-frame is a key frame, which stores/transmits essential data needed to display the frame. The I-frame may be referenced when decoding other types of frames. Typically, I-frames are interspersed with P-frames and B-frames in a compressed video. The more I-frames a video stream contains, the better quality the video. However, I-frames may contain the most amount of bits compared to frames of other types. Therefore, I-frames not only take up more space on the storage medium, but also require more transmission resources, such as radio resources for transmitting over Uu interface, and/or wireline resources for transmitting between network nodes connected by wire/cable.

A P-frame is a delta frame, which contains only the data that have changed from a preceding I-frame (such as color (e.g., chroma, or luma) or content changes). Therefore, decoding a P-frame depends on the preceding I-frame. In other words, if the preceding I-frame is lost or failed to be decoded, a following P-frame may also fail to be decoded, even if the P-frame itself is received without error.

A B-frame is also a delta frame, which contains only the data that have changed from the preceding frame and are different from the data in the following frame (such as the very next frame). Thus, decoding the B-frame depends on the frames preceding and following it.

As can be seen, the I-frame is considered to be the most important frame. If an I-frame is lost, the subsequent B-frame or P-frame may not be decoded in the receiving side. Therefore, it makes sense to assign a PDU set mapped with an I-frame higher QoS priority than a B-frame or a P-frame.

For applications that require high data rate, such as an XR application, due to the high bandwidth requirement, a network congestion may tend to occur. In a network congestion, some PDU sets with lower priority or lower importance may be discarded/dropped before PDU sets with higher priority having to be dropped. For example, a PDU set for an I-frame may be kept but another PDU set for a P-frame or a B-frame may be discarded. If a reception side is aware of the PDU set discarding information (e.g., if the transmission side marks the PDU set as discarded), the reception side may shorten the PDU reordering delay, PDU set reordering delay, the delay caused by delivering PDUs and/or PDU sets (or Service Data Units (SDUs) or SDU sets associated with the PDUs or PDU sets) to upper layers.

Furthermore, if the higher layer in transmission side is aware of the network congestion condition, it may adjust the service transmission strategic to alleviate the congestion situation, e.g., by adjusting the service data rate and/or the service transmission time. If the Network (e.g., base station) and UE is aware of the data transmission termination, UE may stop the PDCCH monitoring timely to save power consumption.

In this disclosure, awareness-based data transmission and reception in radio communication system is introduced. The term “awareness” applies in various aspects.

In one aspect, a transmitting side may be aware of data packet discard information. For example, the transmitting side may be aware that certain PDUs or certain PDU sets are discarded, and may mark these PDUs and/or PDU sets accordingly.

In another aspect, a receiving side may be aware of data packet discard information. For example, by checking the PDU discard information or PDU set discard information transmitted by the transmitting side.

In another aspect, a UE may be aware that it has no further pending transmission task. In this case, the UE may choose to notify the base station and transition to a sleep mode, even the UE is still in an on-duration period.

In another aspect, a base station may be aware that it has no further pending transmission task for a UE. In this case, the base station may choose to notify the UE, so the UE may transition to a sleep mode, even the UE is still in an on-duration period.

In yet another aspect, a UE, based on its own awareness for transmission task, or based on awareness passed from the base station, may dynamically adjust its on-duration period, rather than follow a static on-duration period.

In some implementations, rather than implementing data mapping in a PDU set level, the data mapping may happen at a PDU level. For example, application frame may be mapped to one or more PDUs.

In this disclosure, various embodiments are disclosed for implementing traffic awareness based data transmission and reception.

### Embodiment 1: PDU Discard Indication in PDCP Entity

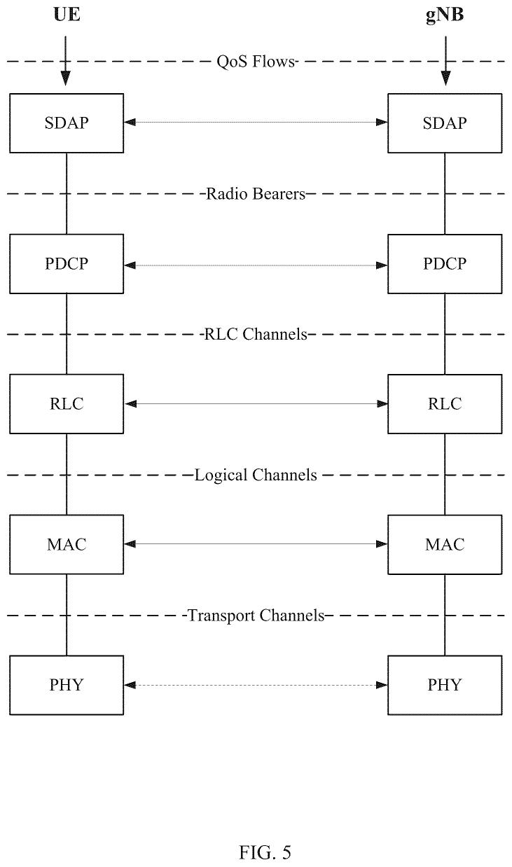

As shown in FIG. 5, an exemplary Radio Access Network (RAN) may include following protocol entities:
Service Data Adaptation Protocol (SDAP) entity;
Packet Data Convergence Protocol (PDCP) entity;
Radio Link Control (RLC) entity;
Medium Access Control (MAC) entity; and
Physical Layer (PHY) entity.

Each entity may correspond to a layer. For example, the PDCP entity corresponds to a PDCP layer, and the RCL entity corresponds to an RLC layer.

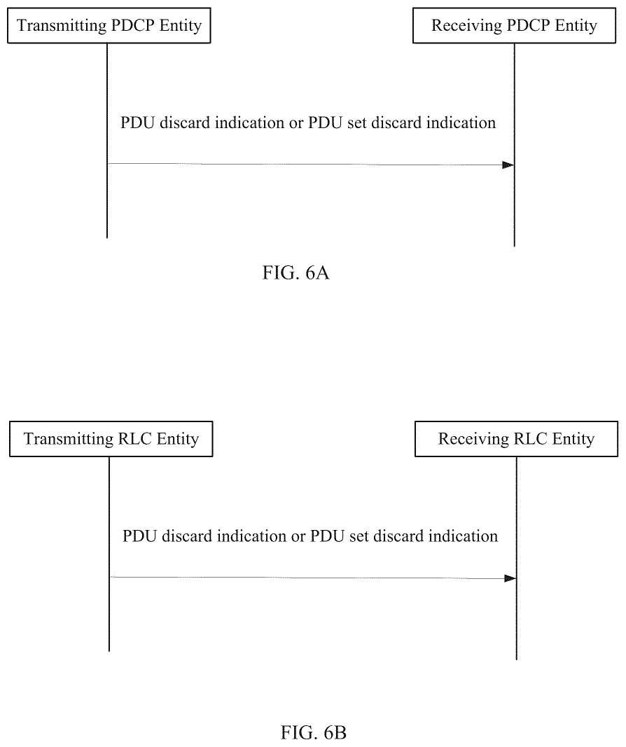

In this embodiment, as shown in FIG. 6A, a PDU discard indication and/or PDU set discard indication may be transmitted from transmitting PDCP entity to receiving PDCP entity. A PDCP entity may be hosted in a wireless terminal such as a UE, a base station, such as a gNB, a CU of a gNB, and the like. A PDCP entity may be implemented as a logical entity, or a physical entity.

If the PDCP entity determines that a PDU or a PDU set should be discarded, it will mark the PDU or the PDU set accordingly. In this disclosure, a PDU or a PDU set marked as discarded may be referred to as a discarded PDU or discarded PDU set. When the receiving entity receives the PDU or PDU set marked as discard (or to-be-discarded), the receiving entity may process them accordingly. For example, the receiving entity may simply drop the discarded PDU or discarded PDU set.

In some exemplary implementations, the PDU/PDU set discard indication may be initiated at the PDCP layer by the transmitting PDCP entity, and received at a peer PDCP layer by the peer receiving PDCP entity. The PDU discard indication and/or PDU set discard indication may be sent in a PDCP control PDU in various formats, or an empty PDCP data PDU (e.g., a PDCP data PDU with no data payload).

Similarly, in some exemplary implementations, the PDU/PDU set discard information may be initiated at the RLC layer by the transmitting RLC entity, and received at a peer RLC layer by the peer receiving RLC entity. The PDU discard indication and/or PDU set discard indication may be sent in an RLC control PDU in various formats, or an empty RLC data PDU (e.g., an RLC data PDU with no data payload).

In this embodiment, the PDCP layer/entity is used for exemplary purpose. It is noted that the same principle may apply to the RLC layer/entity.

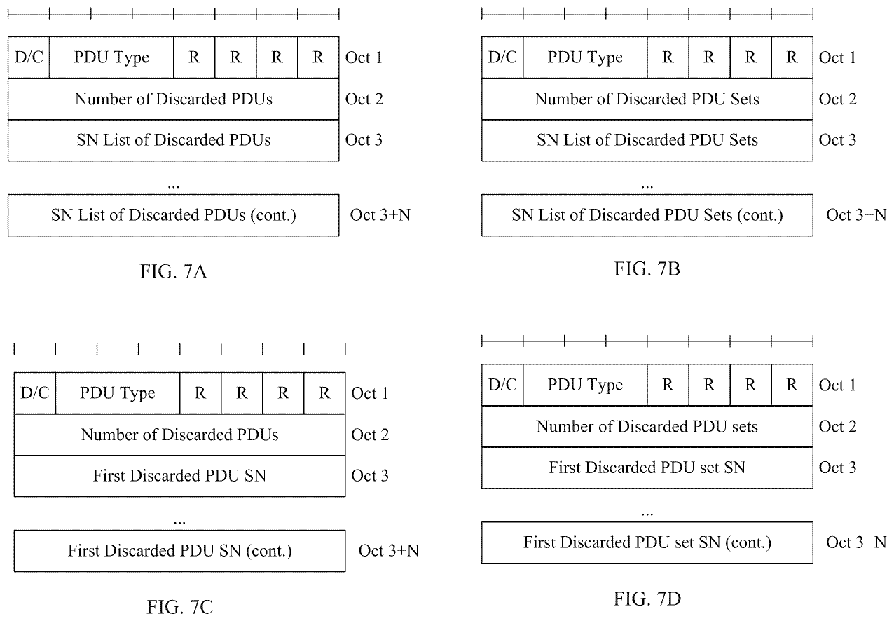

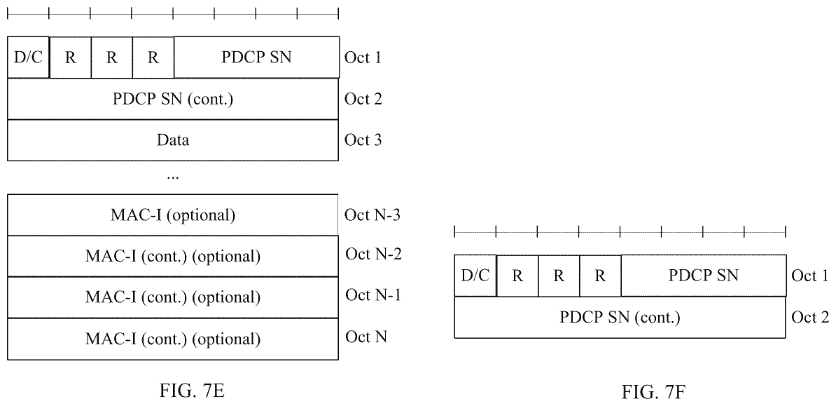

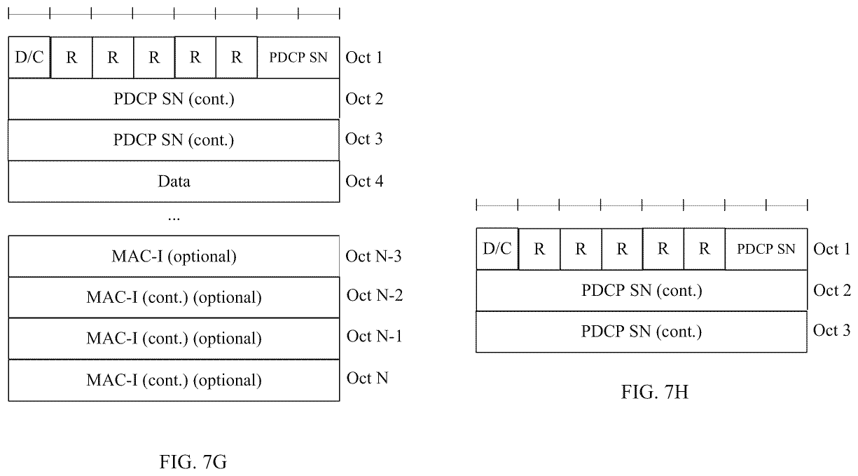

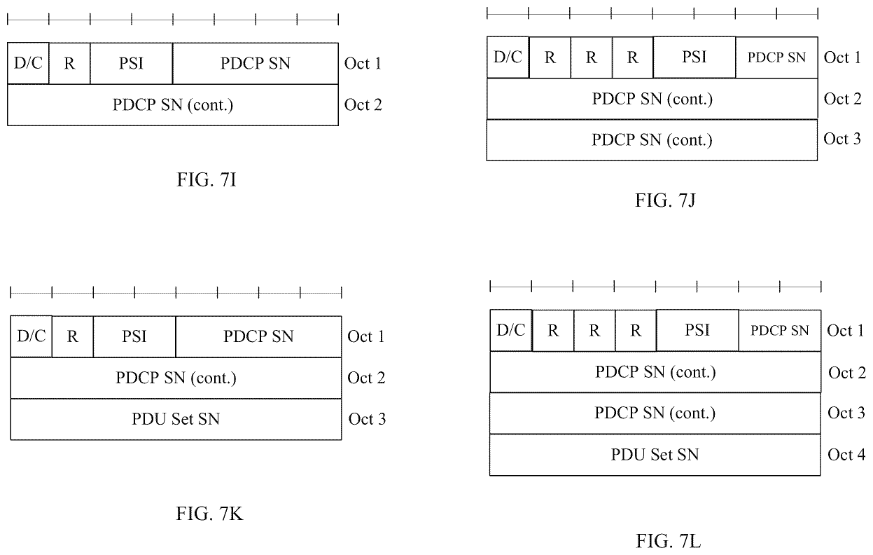

FIG. 7A illustrates an example PDCP control PDU carrying a PDU discard indication. As shown in FIG. 7A, the PDU type field in octet 1 is used to indicate that this PDU is used for PDU discard indication. If the PDU is indicated as being used for PDU discard indication, the PDU may further include: a total number of discarded PDUs, and a sequence number (SN) list with each SN in the list corresponding to a discarded PDU. In this example, the “number of discarded PDUs” field occupies one octet, and each PDU SN occupies one octet. For example, octet 2 indicates the total number of discarded PDUs, which may be used to decide the length of the current PDCP control PDU. Octet 3 to Octet (3+N) may be used to carry a sequence number (SN) list with each SN in the list corresponding to a discarded PDU, where N is a non-negative integer. In this example, the total number of discarded PDUs as indicated in octet 2 equals to the number of SNs in the SN list (i.e., the length or size of the SN list).

Note that in this disclosure, the bit lengths for the proposed fields, such as “number of discarded PDUs” field, “SN list of discarded PDU” field, are for example purpose only. The bit lengths may be adjusted based on practical requirement.

FIG. 7B illustrates an example PDCP control PDU carrying a PDU set discard indication. As shown in FIG. 7B, the PDU type field in octet 1 is used to indicate that this PDU is used for PDU set discard indication. If the PDU is indicated as being used for PDU set discard indication, the PDU may further include: a total number of discarded PDU sets, and an SN list with each SN in the list corresponding to a discarded PDU set. In this example, the total number of discarded PDU sets field occupies one octet, and each SN for a PDU set occupies one octet. For example, octet 2 indicates the total number of discarded PDU sets. Octet 3 to Octet (3+N) may be used to carry a sequence number (SN) list with each SN in the list corresponding to a discarded PDU set, where N is a non-negative integer. In this example, the total number of discarded PDU sets as indicated in octet 2 equals to the number of SNs in the SN list (i.e., the length or size of the SN list).

FIG. 7C illustrates another example PDCP control PDU carrying a PDU discard indication. As shown in FIG. 7C, the PDU type field in octet 1 is used to indicate that this PDU is used for PDU discard indication. If the PDU is indicated as being used for PDU discard indication, the PDU may further include: a total number of discarded PDUs, and an SN for the first discarded PDU. In this example, the total number of discarded PDUs field occupies one octet, and the SN of the first discarded PDU occupies N octet. For example, octet 2 indicates the total number of discarded PDUs. Octet 3 to octet (3+N) indicates the SN of the first discarded PDU, where N is a non-negative integer. In this example, the SNs for the discarded PDUs are continuous. Therefore, based on total number of discarded PDUs and the first discarded PDU, each of the discarded PDUs may be identified. As an example, assuming the SN for the first discarded PDU is 101 (i.e., 101 is the start SN for discarded PDUs), and the total number of discarded PDU is 8, then PDUs with SNs from 101 to 108 are discarded.

In this example, the size of the PDCP control PDU is less than that of the PDCP control PDU as shown in FIG. 7A.

FIG. 7D illustrates an example PDCP control PDU carrying a PDU set discard indication. As shown in FIG. 7D, the PDU type field in octet 1 is used to indicate that this PDU is used for PDU set discard indication. If the PDU is indicated as being used for PDU set discard indication, the PDU may further include: a total number of discarded PDUs, and an SN for the first discarded PDU set. In this example, the total number of discarded PDU sets field occupies one octet, and the SN of the first discarded PDU occupies N octet. For example, octet 2 indicates the total number of discarded PDU sets. Octet 3 to octet (3+N) indicates the SN of the first discarded PDU set, where N is a non-negative integer. In this example, the SNs for the discarded PDU sets are continuous. Therefore, based on total number of discarded PDU sets and the first discarded PDU set, each of the discarded PDU sets may be identified. As an example, assuming the SN for the first discarded PDU set is 101 (i.e., 101 is the start SN for discarded PDU sets), and the total number of discarded PDU set is 8, then PDU sets with SNs from 101 to 108 are discarded.

In this example, the size of the PDCP control PDU is less than that of the PDCP control PDU as shown in FIG. 7B.

In some exemplary implementations, the PDU discard indication and/or PDU set discard indication may be implicitly indicated by a PDCP data PDU itself, rather than using a dedicated control PDU.

FIG. 7E shows an example format for a PDCP data PDU. This example PDCP data PDU may be associated with Data Radio Bears (DRBs). The PDCP data PDU includes a PDCP SN (also referred to as PDCP PDU SN, or PDU SN for simplicity) field, which has 12 bits. The length of the PDCP SN field may take other lengths, such as 18 bits, as shown in FIGS. 7G and 7H. When there is not data field or data section in a PDCP data PDU, as shown in FIGS. 7F and 7H, it is implicitly indicated that this PDCP data PDU is discarded.

A PDU set may include one or more PDUs. For example, a PDU may be the only PDU in a PDU set; a PDU may be the first PDU (i.e., start PDU) in a PDU set; a PDU may be the last PDU in a PDU set; or a PDU may be the middle PDU (i.e., between start PDU and end PDU) in a PDU set.

In some exemplary implementations, a PDU Set Info (PSI) field may be introduced to a PDCP data PDU, to indicate PDU set discard indication. The PSI field may indicate whether a current PDU is the only PDU in a PDU set; whether the current PDU is the first PDU (i.e., start PDU) of the PDU set, whether the current PDU is in the middle of the PDU set, or whether the current PDU is the last PDU of a PDU set. An example interpretation of a PSI field with 2 bits length is shown in table 1 below.

TABLE 1
PSI Field Interpretation

| PSI Field Value | Description |
|---|---|
| 00 | The PDU is the only PDU in a PDU set. |
| 01 | The PDU is the first PDU of a PDU set. |
| 10 | The PDU is the last PDU of a PDU set. |
| 11 | The PDU is the middle PDU (i.e., between |
| | the first PDU and the last PDU) of a PDU set. |

Note that table 1 is merely for exemplary purpose. Following the same underlying principle, the mapping between the values of the PSI field and the interpretation may change. For example, a PSI value “01” may be used to indicate that the PDU is the last PDU of a PDU set, and 10 can be used to indicate that the PDU is the first PDU of a PDU set.

FIG. 71 shows an example PDCP data PDU with a PSI field. In this example, the SN of the PDU is 12 bits. Note that there is no data field in this example PDU, which implicitly indicates that this PDU is discarded. In some implementations, if one PDU in a PDU set is marked as discarded, the whole PDU set may be implicitly indicated as discarded. For example, if the PDU as shown in FIG. 71 is indicated as the first PDU of a PDU set, then the rest PDUs in the same PDU set (which may be indicated by the PSI fields) may also need to be discarded.

FIG. 7J shows another example PDCP data PDU with a PSI field. The SN of the PDU is 18 bits, and there is no data field in this PDCP data PDU.

In some exemplary implementations, in addition to the PSI field, a PDU set SN field may be added to the PDCP data PDU, to indicate the SN of the discarded PDU set. With the addition of the PDU set SN field, not only the relative position of the PDU in a PDU set is indicated, the SN of the PDU set is also indicated. Therefore, on the reception end of the PDCP data PDU, the receiving entity may gain further knowledge on the discarded PDU set.

FIG. 7K shows an example PDCP data PDU with the PDU set SN field. In this example, the SN of the PDU is 12 bits. Note that the PDU does not have a data field, which implicitly indicate that the PDU is discarded.

FIG. 7L shows another example PDCP data PDU with the PDU set SN field. In this example, the SN of the PDU is 18 bits. Note that the PDU does not have a data field, which implicitly indicate that the PDU is discarded.

### Embodiment 2: PDU Discard Indication in RLC

In this embodiment, as shown in FIG. 6B, a PDU discard indication and/or a PDU set discard indication may be transmitted from a transmitting RLC entity to a receiving RLC entity. An RLC entity may be hosted in a wireless terminal such as a UE; a base station, such as a gNB, a DU of a gNB; and the like. An RLC entity may be implemented as a logical entity, or a physical entity.

In some exemplary implementations, the PDU discard indication and/or PDU set discard indication may be sent in an RLC control PDU, such as an RLC status PDU, or an empty RLC data PDU. Detailed Reference for the format and usage of the RLC status PDU and the empty RLC data PDU may be found in embodiment 1. In a high level, the following describes the format and usage of the RLC status PDU and the empty RLC data PDU.

In some exemplary implementations, the PDU discard indication and/or PDU set discard indication may be sent in an RLC status PDU. In this embodiment, a new format is defined for an RLC status PDU. This new RLC status PDU may include discarded PDU information or discarded PDU set information, to indicate whether a PDU (or a list of PDUs) and/or a PDU set (or a list of PDU sets) is discarded.

In some exemplary implementations, the PDU discard indication and/or PDU set discard indication may be implicitly indicated by an empty RLC data PDU. When there is no data field included in an RLC data PDU (e.g. the RLC data PDU is an empty packet, or the RLC data PDU includes no payload), it indicates that the PDU is discarded. The RLC data PDU may include a SN for a discarded PDU or discarded PDU set, or a list of SNs for a list of discarded PDUs or discarded PDU sets.

In some exemplary implementations, PDU set is supported during a PDU session. In an RLC layer, Service Data Units (SDUs) may be encapsulated in multiple PDUs in a PDU set. If one or more PDU in a PDU set is indicated as discarded by the transmitting entity, or the whole PDU set is indicated as discarded by the transmitting entity, the SDUs encapsulated in the PDU set as a whole lose its integrity. For example, PDU 5 in a PDU set with 10 PDUs is indicated as discarded. The receiving entity such as the RLC entity detects that the PDU 5 is marked as discarded from the transmitting entity. In this case, the receiving RLC entity may immediately stop processing the PDU set and drop all the SDUs encapsulated in the PDU set, without delivering any SDUs encapsulated in the PDU set to an upper layer. Refer to FIG. 5 for the protocol/layer stack and relationship between upper and lower layers. In this particular example, as the receiving entity is the RLC entity, the RLC entity will not deliver any SDUs encapsulated in the PDU set to the PCDP layer. Therefore, no extra processing is needed in the upper layer for these SDUs which lose integrity. The prompt drop of these SDUs may not only improve the efficiency, for example, in the RLC layer and layers above, but also save the energy consumption in the network elements (e.g., UE, base station, etc.) hosting the receiving RLC entity due to reduced processing effort. The RLC layer may only deliver the SDUs to its upper layer (i.e., PDCP layer) if all the SDUs in a PDU set is received thus passing the integrity test.

In some exemplary implementations, PDU set is not supported during a PDU session. The PDU transmission is in the unit of PDU, rather than in the unit of PDU set. The receiving RLC entity may still perform SDU integrity check. In an RLC layer, an SDU may be encapsulated in a PDU. If a PDU is indicated as discarded by the transmitting entity, the SDU encapsulated in the PDU loses its integrity. The receiving entity such as the RLC entity may detect that a PDU is discarded from the transmitting entity. In this case, the receiving RLC entity may immediately stop processing or dropping the PDU marked as discarded, without even attempting to decapsulate SDU in the PDU.

Once the receiving entity becomes aware of that certain PDUs or PDU sets are discarded from the transmitting entity, it will not attempt to perform any further processing for these discarded PDUs or PDU sets. Further, other tasks on the receiving side, such as re-ordering task, buffering task, may proceed based on the awareness that certain PDUs or PDU sets are discarded. Since the awareness is based on discard indication, the receiving side does not need to apply any in-depth inspection logics.

The similar SDU integrity check may also be performed in other layers, such as the PDCP layer. For example, if any PDU in a PDU set is marked as discarded, the PDCP layer may drop the whole PDU set and will not deliver any SDU encapsulate in the PDU set to its upper layer, which is the SDAP layer.

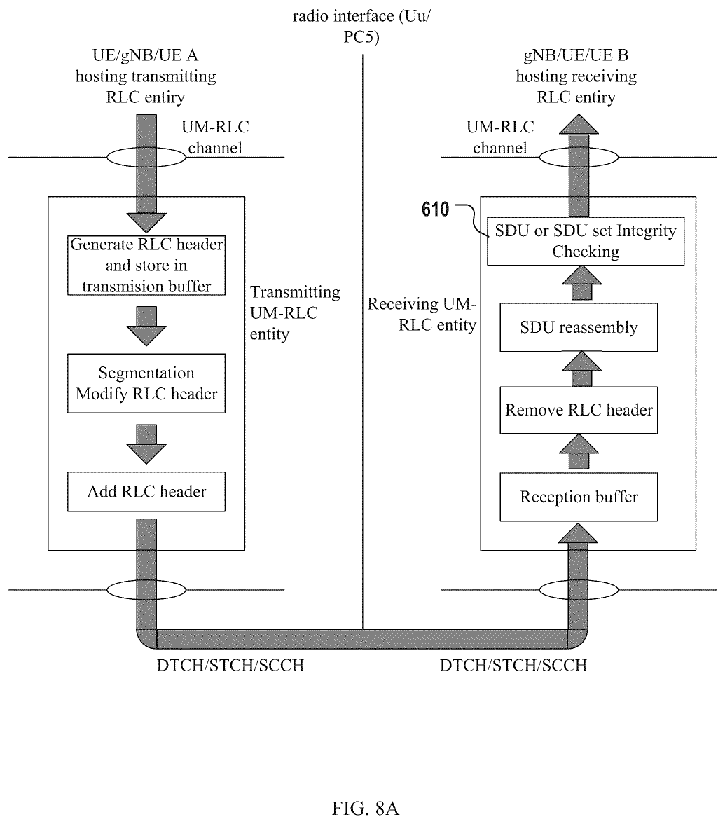

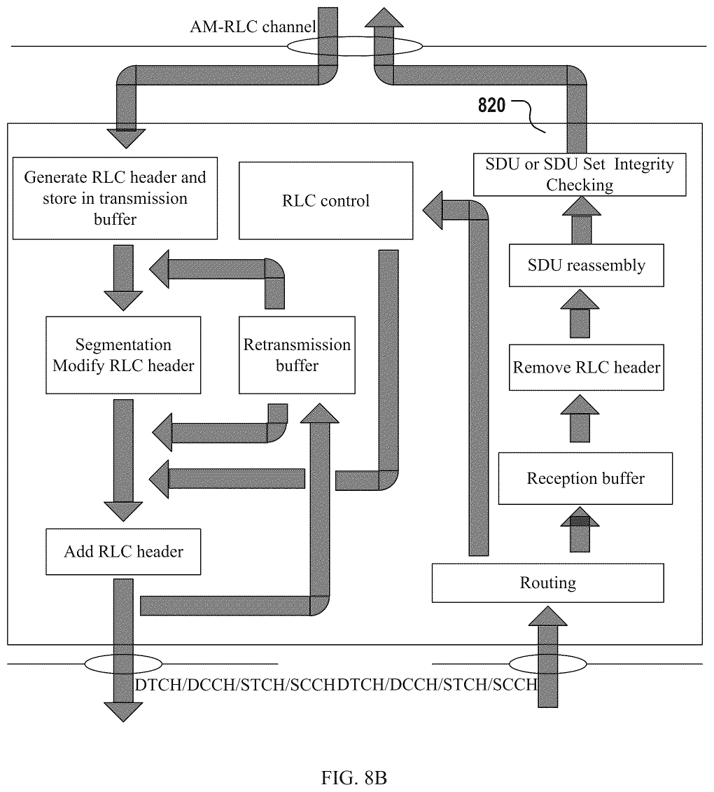

FIG. 8A illustrates an exemplary receiving RLC entity operating in Un-acknowledge Mode (UM) with SDU (or SDU set) integrity check 810. In this example, the transmitting RLC entity may be hosted by a UE, or a gNB, corresponding to the receiving RLC entity hosted by a gNB, or a UE. The transmitting RLC entity and the receiving RLC entity may also be hosted by UE A and UE B, respectively. Further, the interface between the transmitting RLC entity and the receiving RLC entity may include a radio interface, such as a Uu interface between UE and gNB, or a PC5 interface between two UEs.

FIG. 8B illustrates an exemplary receiving RLC entity operating in Acknowledge Mode (AM) with SDU (or SDU set) integrity check 820.

In this embodiment, for exemplary purpose, the SDU/SDU set integrity check is performed at RLC layer. Similar integrity check may also be performed at other layers such as PDCP layer. For example, the PDCP layer may only deliver the SDU set associated with a PDU set to an upper layer (e.g., SDAP layer), if the PDU set is not marked as discarded. The receiving PDCP entity, once detects that a PDU set is marked as discarded, may drop the whole PDU set expressly, without any further processing on the discard PDU set and without delivering to the SDAP layer any SDUs associated with the PDU set.

### Embodiment 3: Uplink Transmission or PDU Set Transmission End Indication from UE

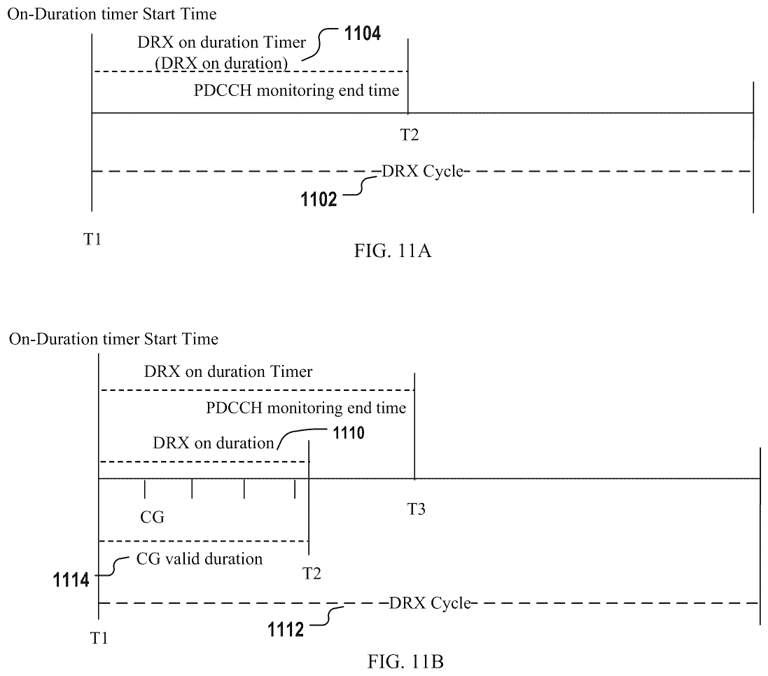

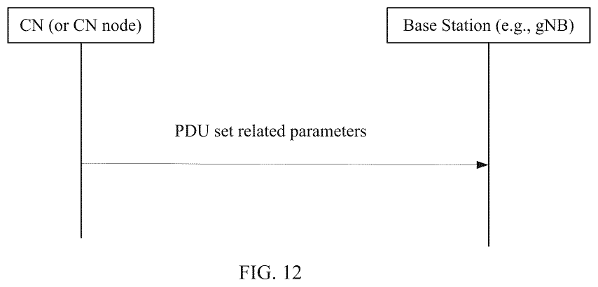

In wireless communication, the Discontinuous Reception (DRX) mode is introduced for UE and/or base station for energy saving. As shown in FIG. 11A, in DRX mode, a UE may wake up periodically based on a periodicity (DRX cycle 1102). In each DRX cycle, there may be an on-duration period 1104, in which the UE is awake and is able to perform uplink transmission and/or downlink reception. The on-duration period 1104 may be tracked by the DRX on-duration timer. In current practice, the on-duration period is fixed once a specific DRX configuration is applied. As shown in FIG. 11A, the on-duration period 1104 starts at T1 and ends at T2. However, a UE may finish its transmission task earlier, and does not need to use the whole on-duration period. It is beneficial for the UE to report this situation to the bases station, so UE may transition to sleep mode earlier (before the on-duration period ends). Meanwhile, the base station may also be eased from attempting to receive uplink data from UE, as the UE does not have further uplink data for transmission in the current DRX cycle. Or the base station may stop scheduling downlink transmission in the current DRX cycle for the UE.

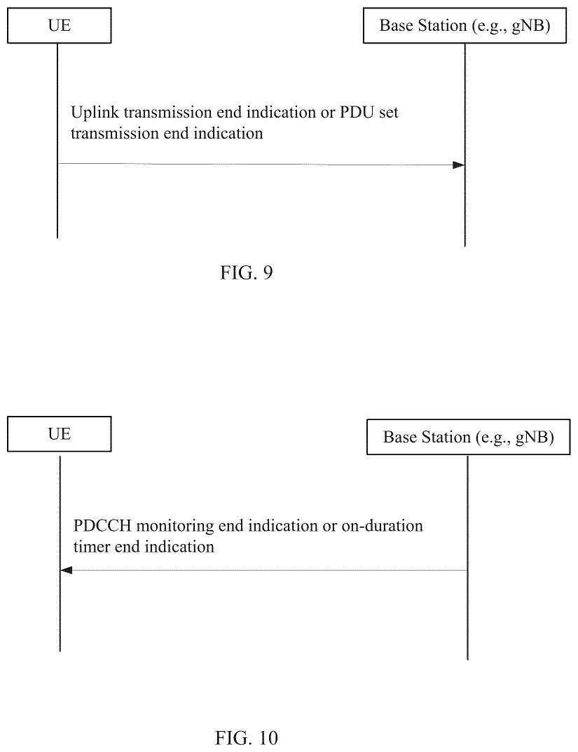

Referring to FIG. 9, in this embodiment, the UE may send an early termination indication to the base station, to indicate that an uplink transmission, or a PDU set transmission is complete.

The early termination indication may be sent from the UE to the base station by at least one of:
a Buffer Status Reporting (BSR) message indicating a buffer size of the UE being zero;
a Medium Access Control-Control Element (MAC CE) message, the MAC CE message is associated with or identified by a dedicated uplink Logical Channel Identifier (LC-ID) and includes no data payload. In one implementation, the dedicated uplink LC-ID may be associated with an uplink data transmission;
an Uplink Control Information (UCI) message indicating that the uplink transmission is complete; or
an uplink transmission ending flag indicating that the uplink transmission is complete.

The uplink transmission ending flag may be included in a PDU (e.g., appended in a PDU), such as the last PDU of the uplink transmission. The uplink transmission ending flag may also be included in a PDU set, such as the last PDU set of the uplink transmission. The uplink transmission ending flag may also be sent via a separate message.

In some exemplary implementations, after the UE sends the early termination indication, the UE may stop monitoring the PDCCH in the current DRX cycle even if the UE is still in an on-duration period. That is, the UE may act as if the DRX on-duration timer expires and/or the DRX Inactivity Timer is set to zero.

### Embodiment 4: PDCCH Monitoring and/or On-Duration Timer End Indication from Base Station

When the base station schedules downlink transmission for the UE, it may have the intelligence to know that there is no further downlink data for UE. For example, even if the UE is still in the on-duration period, the base station may determine that there is no further downlink data for the UE in the current DRX cycle. In this case, rather than let UE keep staying in the awake state, the base station may choose to notify UE about early termination of downlink data transmission, so the UE may be able to transition to sleep mode earlier, to reduce power consumption.

Referring to FIG. 10, in this embodiment, the base station may send an early termination indication to the UE, to indicate that the UE may stop PDCCH monitoring, or the UE may stop the on-duration timer, so the UE may transition to sleep mode.

The early termination indication may be sent from the base station to the by at least one of:
a MACE CE message, the MAC CE message, the MAC CE message is is associated with or identified by a dedicated downlink LC-ID and includes no data payload. In one implementation, the dedicated downlink LC-ID is associated with downlink data transmission;
a PDCCH Downlink Control Information (DCI) message indicating that the downlink transmission is complete; or
a downlink transmission ending flag indicating that the downlink transmission is complete.

The downlink transmission ending flag may be included in a PDU (e.g., appended in a PDU), such as the last PDU of the downlink transmission. The downlink transmission ending flag may also be included in a PDU set, such as the last PDU set of the downlink transmission. The downlink transmission ending flag may also be sent via a separate message.

In some exemplary implementations, after the UE receives the early termination indication, the UE may stop monitoring the PDCCH in the current DRX cycle even if the UE is still in an on-duration period. That is, the UE may act as if the DRX on-duration timer expires and/or the DRX Inactivity Timer is set to zero.

### Embodiment 5: Sliding On-duration Period

As described in earlier, in a DRX cycle, the DRX on-duration period may be tracked by a DRX on-duration timer. For example, the on-duration period ends when the DRX on-duration timer expires. In current practice, the on-duration period is fixed once a specific DRX configuration is applied.

In this embodiment, a sliding on-duration period is introduced. As shown in FIG. 11B, in DRX cycle 1112, the DRX on-duration timer expires at T3. There is a DRX on-duration 1110, which starts at T1 and ends at T2. T2 may be a sliding time point which may slide between T1 and T3. Under certain conditions, the UE and/or the base station may determine there is no more pending transmission for the UE, so T2 may be adjusted dynamically, once there is no pending downlink and/or uplink transmission task.

In some exemplary implementations, the UE may determine to end the DRX on-duration before T3. In this case, the UE may notify the base station about the early termination of the DRX on-duration, by sending to the base station at least one of:
a BSR message indicating a buffer size of the UE being zero;
a MAC CE message, the MAC CE message is associated with or identified by a dedicated uplink LC-ID and includes no data payload;
an Uplink Control Information (UCI) message indicating that the on-duration time period in the DRX cycle is ending; or
an ending flag indicating that the on-duration time period in the DRX cycle is ending.

If the UE determines that an early termination of the DRX on-duration does not apply, then the DRX on-duration will end once the DRX on-duration timer expires.

In some exemplary implementations, the base station may determine to end the DRX on-duration before T3. In this case, the base station may notify the UE about the early termination of the DRX on-duration, by sending to the UE at least one of:
a MACE CE message, the MAC CE message is associated with or identified by a dedicated uplink LC-ID and includes no data payload;
a Downlink Control Information (DCI) message indicating that the downlink transmission is complete; or
a downlink transmission ending flag indicating that the downlink transmission is complete.

In some exemplary implementations, the UE may further determine a validation period for Configured Grant (CG) resource base on the DRX on-duration period. As shown in FIG. 11B, the CG resource valid duration 1114 may be based on the DRX on-duration 1110. As an example, the CG resource valid duration 1114 may be the same as the DRX on-duration 1110.

During DRX on-duration period 1110, the CG resources, such as CG resources for Scheduling Request (SR) or for BSR are valid. The CG resources may be used for uplink quasi-periodical traffic, e.g., periodical traffic with arrive time jitter. When uplink traffic arrives, UE can send SR or BSR using the pre-configured CG resource, which may reduce the uplink transmission delay. When the uplink traffic ends, UE may stop to monitor PDCCH and release the CG resources, which can save UE power and radio resource.

### Embodiment 6: PDU Set Related Parameters

In the embodiment, the Core Network (CN) may send PDU set related parameters to the base station using a message, such as a UE associated signaling.

The PDU set related parameters includes at least one of the following:

A survival time indicating one of: a maximal time period that a PDU set is valid, or a maximal time period that an application can survive without receiving any data burst.

A PDU set start time indicating a start time of the PDU set, e.g., the arrival time of the first PDU (i.e., start PDU) in the PDU set.

A PDU set end time indicating an end time of the PDU set, e.g., the arrival time of the last PDU in the PDU set.

A PDU set duration indicating a PDU set duration (e.g. the time duration from the arrival time of the first PDU in the PDU set to the arrival time of the last PDU in the PDU set).

A packet periodicity for packets in the PDU set.

A packet interval for packets in the PDU set.

A number of packets in the PDU set.

A packet size for each packet in the PDU set.

A packet size variance of the packets in the PDU set. This may be expected variance of the packets generated, which may be used to determine the packet size range.

A packet size of a first packet in the PDU set. This may be useful for periodical traffic. For example, for determining or selecting the configured grant configuration, or the Semi-Persistent Scheduling (SPS) configuration for the first packet in the PDU set of the periodical traffic. The residual packet of the PDU set may be scheduled dynamically.

A minimum size of the PDU set. This may be used for determining or selecting the CG or SPS configuration for the PDU set. The residual packet of the PDU set may be scheduled dynamically.

A Packet Delay Budget (PDB) per Quality of Service (QOS) sub flow. This may used to indicate an upper bound for the time that a packet in the QoS sub-flow may be delayed between the UE and the N6 termination point at the User Plane Function (UPF). When PDB of the QoS sub flow is received, the gNB may apply this PDB value to the corresponding QoS sub flow. In case that QOS sub flow is received but PDB of the QoS sub flow is not received, the gNB may use the PDB value of the related QOS flow for the QoS sub flow (e.g., if the PDB is only configured in a per QoS flow level, then the per QoS flow level PDB may be applied to QOS sub flow within the QoS flow).

A Packet Error Rate (PER) per QoS sub flow. This may used to indicate an upper bound for packet error rate per QoS sub flow. When PER of the QoS sub flow is received, the gNB apply this PER value to the corresponding QoS sub flow. In case QOS sub flow is received but PER of the QoS sub flow is not received, the gNB may the PER value of the related QoS flow for the QoS sub flow (e.g., if the PER is only configured in a per QoS flow level, then the per QoS flow level PER may be applied to QoS sub flow within the QoS flow).

A PDB per QoS sub flow for core network (CN PDB). This may be used to indicate the delay between any N6 termination point at the UPF (for any UPF that may possibly be selected for the PDU session) and the 5G-AN in the QoS sub-flow. When CN PDB of the QoS sub flow is received, the gNB may apply the CN PDB value to the corresponding QoS sub flow. In case QoS sub flow is received but CN PDB of the QoS sub flow is not received, the gNB may apply the CN PDB value of the related QoS flow to the QoS sub flow (e.g., if the CN PDB is only configured in a per QoS flow level, then the per QoS flow level CN PDB may be applied to QoS sub flow within the QoS flow).

A PDU set delay budget indicating an upper bound for a time duration from a first packet transmission to a last packet reception of a PDU set between a given set of nodes.

### Embodiment 7

In this embodiment, congestion indication information may be exchanged between different network elements, for example, between a UE and a base station, or between a base station and a core network (or a core network node). Congestion indication information may also be exchanged between an application layer (e.g., a data network) and various entities or modules in a UE, for example, a 5G system (5GS) module in the UE.

The congestion indication information may include at least one of the following:
A network element is congested or not congested;
A congestion level of a network element, selected from a pre-defined list of congestion levels;
An overload state indication;
A resource congestion status indication; or
A higher Quality of Experience (QoE) preferred indication.

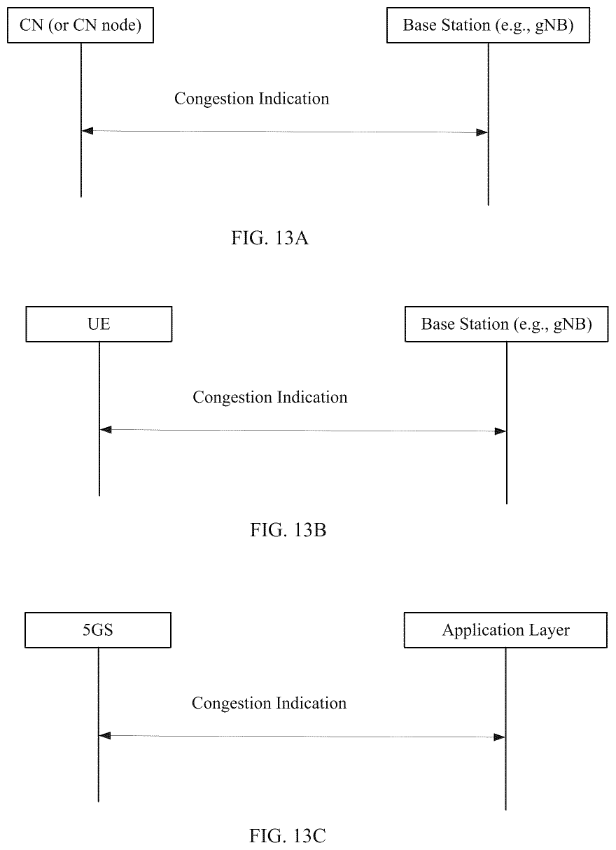

FIG. 13A illustrates the congestion indication information exchanged between a core network (or a core network node) and a base station. The congestion indication information may be sent by a UE associated signaling, a cell-level signaling, a gNB level signaling, or a GPRS Tunnelling Protocol User Plane (GTP-U) header.

FIG. 13B illustrates the congestion indication information exchanged between a base station and a UE. The congestion indication information may be sent by a MAC CE, an RRC signaling (e.g., a UEAssistanceInformation message), a UCI, a PDCP header, or an RLC header.

FIG. 13C illustrates the congestion indication information exchanged between a 5GS and an application layer. The congestion indication information may be sent by a transport layer protocol (e.g., Transport Control Protocol (TCP), IP, User Datagram Protocol (UDP), ethernet frame structure, etc.). The congestion indication information may also be sent based on equipment implementation between Access Stratum (AS), Non-Access Stratum (NAS), and higher layers.

The description and accompanying drawings above provide specific example embodiments and implementations. The described subject matter may, however, be embodied in a variety of different forms and, therefore, covered or claimed subject matter is intended to be construed as not being limited to any example embodiments set forth herein. A reasonably broad scope for claimed or covered subject matter is intended. Among other things, for example, subject matter may be embodied as methods, devices, components, systems, or non-transitory computer-readable media for storing computer codes. Accordingly, embodiments may, for example, take the form of hardware, software, firmware, storage media or any combination thereof. For example, the method embodiments described above may be implemented by components, devices, or systems including memory and processors by executing computer codes stored in the memory.

Throughout the specification and claims, terms may have nuanced meanings suggested or implied in context beyond an explicitly stated meaning. Likewise, the phrase “in one embodiment/implementation” as used herein does not necessarily refer to the same embodiment and the phrase “in another embodiment/implementation” as used herein does not necessarily refer to a different embodiment. It is intended, for example, that claimed subject matter includes combinations of example embodiments in whole or in part.

In general, terminology may be understood at least in part from usage in context. For example, terms, such as “and”, “or”, or “and/or,” as used herein may include a variety of meanings that may depend at least in part on the context in which such terms are used. Typically, “or” if used to associate a list, such as A, B or C, is intended to mean A, B, and C, here used in the inclusive sense, as well as A, B or C, here used in the exclusive sense. In addition, the term “one or more” as used herein, depending at least in part upon context, may be used to describe any feature, structure, or characteristic in a singular sense or may be used to describe combinations of features, structures or characteristics in a plural sense. Similarly, terms, such as “a,” “an,” or “the,” may be understood to convey a singular usage or to convey a plural usage, depending at least in part upon context. In addition, the term “based on” may be understood as not necessarily intended to convey an exclusive set of factors and may, instead, allow for the existence of additional factors not necessarily expressly described, again, depending at least in part on context.

Reference throughout this specification to features, advantages, or similar language does not imply that all of the features and advantages that may be realized with the present solution should be or are included in any single implementation thereof. Rather, language referring to the features and advantages is understood to mean that a specific feature, advantage, or characteristic described in connection with an embodiment is included in at least one embodiment of the present solution. Thus, discussions of the features and advantages, and similar language, throughout the specification may, but do not necessarily, refer to the same embodiment.

Furthermore, the described features, advantages and characteristics of the present solution may be combined in any suitable manner in one or more embodiments. One of ordinary skill in the relevant art will recognize, in light of the description herein, that the present solution may be practiced without one or more of the specific features or advantages of a particular embodiment. In other instances, additional features and advantages may be recognized in certain embodiments that may not be present in all embodiments of the present solution.

1. A method for wireless communication, performed by a first network element, the method comprising one of:
providing, to a second network element, a first discard indication indicating a list of discarded Protocol Data Units (PDUs) or a list of discarded PDU sets, each discarded PDU set in the list of discarded PDU sets comprising a list of PDUs, wherein the first discard indication triggers the second network element to discard the list of discarded PDUs or the list of discarded PDU sets; or
providing, to the second network element, a second discard indication indicating that a PDU is discarded or a PDU set is discarded, wherein the second discard indication triggers the second network element to discard the PDU or the PDU set.

2. The method of claim 1, wherein the list of the discarded PDUs or the list of discarded PDU sets is associated with a PDU session of the first network element.

3. The method of claim 1, wherein the first discard indication or the second discard indication is initiated from a layer in a protocol stack comprising at least one layers.

4. The method of claim 1, wherein providing, to the second network element, the first discard indication comprises:
providing, to the second network element, the first discard indication via a control PDU, the first discard indication indicating the list of discarded PDUs or the list of discarded PDU sets.

5. The method of claim 4, wherein the control PDU comprises at least one of:
a PDU type field indicating the control PDU being used for PDU discard indication;
a size of the list of discarded PDUs;
a list of PDU Sequence Numbers (SNs) indicating the list of discarded PDUs;
a size of the list of discarded PDU sets; or
a list of SNs indicating the list of discarded PDU sets.

6. The method of claim 4, wherein the control PDU comprises at least one of:
a PDU type field indicating the control PDU being used for PDU discard indication;
a size of the list of discarded PDUs;
an SN of a start PDU in the list of discarded PDUs, SNs of elements in the list of discarded PDUs being continuous;
a size of the list of discarded PDU sets; or
an SN of a first PDU set in the list of discarded PDU sets, SNs of elements in the list of discarded PDU sets being continuous.

7. The method of claim 4, wherein:
the first discard indication is initiated in a Packet Data Convergence Protocol (PDCP) layer, by a PDCP entity hosted by the first network element; and
providing, to the second network element, the first discard indication comprises:
providing, to a PDCP entity hosted by the second network element, the first discard indication indicating the list of discarded PDUs or the list of discarded PDU sets; and
the control PDU comprises a PDCP control PDU.

8. The method of claim 4, wherein:
the first discard indication is initiated in a Radio Link Control (RLC) layer, by an RLC entity hosted by the first network element; and
providing, to the second network element, the first discard indication comprises:
providing, to an RLC entity hosted by the second network element, the first discard indication indicating the list of discarded PDUs or the list of discarded PDU sets; and
the control PDU comprises an RLC control PDU.

9. The method of claim 1, wherein:
the PDU is a data PDU; and
providing, to the second network element, the second discard indication indicating that the PDU is discarded or the PDU set is discarded comprises:
providing, to the second network element, the data PDU with no data field, wherein an absence of the data field in the data PDU implicitly indicates that the data PDU is discarded.

10. The method of claim 1, wherein:
the PDU is a data PDU in the PDU set; and
providing, to the second network element, the second discard indication indicating that the PDU is discarded or the PDU set is discarded comprises:
providing, to the second network element, the data PDU with no data field, wherein an absence of the data field in the data PDU implicitly indicates that the PDU set is discarded.

11. The method of claim 9, wherein:
the second discard indication is initiated in a PDCP layer, by a PDCP entity hosted by the first network element; and
providing, to the second network element, the second discard indication comprises:
providing, to a PDCP entity hosted by the second network element, the second discard indication indicating the list of discarded PDUs or the list of discarded PDU sets; and
the data PDU comprises an PDCP data PDU.

12. The method of claim 9, wherein:
the second discard indication is initiated in an RLC layer, by an RLC entity hosted by the first network element; and
providing, to the second network element, the second discard indication comprises:
providing, to an RLC entity hosted by the second network element, the second discard indication indicating the list of discarded PDUs or the list of discarded PDU sets; and
the data PDU comprises an RLC data PDU.

13. (canceled)

14. The method of claim 1, wherein:
the PDU is a data PDU in the PDU set;
the PDU comprises an identifier of the PDU set, the identifier of the PDU set comprising an SN of the PDU set; and
providing, to the second network element, the second discard indication indicating that the PDU is discarded or the PDU set is discarded comprises:
providing, to the second network element, the data PDU with no data field, wherein an absence of the data field in the data PDU implicitly indicates that the PDU set identified by the identifier of the PDU set is discarded.

15. (canceled)

16. The method of claim 1, wherein a combination of the first network element and the second network element comprises at least one of:
the first network element comprises a first User Equipment (UE), and the second network element comprises a base station;
the first network element comprises the base station, and the second network element comprises the first UE; or
the first network element comprises the first UE, and the second network element comprises a second UE.

17. A method for wireless communication, performed by a first network element, the method comprising:
receiving, from a second network element and by a receiving entity hosted in the first network element, a discard indication indicating a list of discarded PDUs or a list of discarded PDU sets, each PDU set in the list of discarded PDU sets comprising a list of PDUs; and
dropping the list of discarded PDUs or the list of discarded PDU sets at a receiving layer corresponding to the receiving entity.

18. The method of claim 17, wherein the list of the discarded PDUs or the list of discarded PDU sets is associated with a PDU session of the second network element, and wherein the discard indication is initiated from a layer in a protocol stack comprising at least one layers.

19. (canceled)

20. The method of claim 17, wherein the discard indication is received by an RLC entity hosted by the first network element, and wherein receiving, from the second network element, the discard indication comprises:
receiving, from an RLC entity hosted by the second network element, the discard indication indicating the list of discarded PDUs or the list of discarded PDU sets.

21. The method of claim 17, wherein the discard indication is received by a PDCP entity hosted by the first network element, and wherein receiving, from the second network element, the discard indication comprises:
receiving, from a PDCP entity hosted by the second network element, the discard indication indicating the list of discarded PDUs or the list of discarded PDU sets.

22. The method of claim 17, wherein dropping the list of discarded PDUs or the list of discarded PDU sets comprises:
dropping the list of discarded PDUs or the list of discarded PDU sets at a receiving layer corresponding to the receiving entity, without delivering any data payload associated with the list of discarded PDUs or the list of discarded PDU sets to an upper layer of the receiving layer.

23. The method of claim 17, wherein a combination of the first network element and the second network element comprises at least one of:
the first network element comprises a first User Equipment (UE), and the second network element comprises a base station;
the first network element comprises the base station, and the second network element comprises the first UE; or
the first network element comprises the first UE, and the second network element comprises a second UE.

24-43. (canceled)
